(19) United States
(12) Patent Application Publication
(10) Pub. No.: US 2002/0109277 A1
(43) Pub. Date: Aug. 15, 2002

(54) Shock and vibration absorption system

(76) Inventor: Stewart Correll, Reston, VA (US)

Correspondence Address: Kevin M. Curran, Kramer Levin Naftalis & Frankel LLP, 919 Third Avenue, New York, NY, 10022, US

(21) Appl. No.: 09/780,782

(22) Filed: Feb. 9, 2001

(51) Int. Cl. F16M 1/00

(52) U.S. Cl. 267/136

(57) ABSTRACT

A shock and vibration absorption system and method include a first support device, a second support device, and one or more elastic members arranged within one or more cavities formed between the first support device and the second support device. External shock or vibration cause the first support device and the second support device to adjust relative to each other, thereby compressing the elastic members. Compression of the elastic members attenuates the shock and vibration. The system may be used in a wide variety of applications, either alone or in combination with track systems, positioning systems or other shock and vibration absorption mechanisms and methods.

### FIELD OF THE INVENTION

The present invention relates to a shock and vibration absorption system, that can be used in a variety of applications such as a dual-structure, shock- and vibration-absorbent shelving system.

### BACKGROUND INFORMATION

Shock and vibration absorption are necessary for a variety of needs and equipment and under a variety of conditions. For example, sensitive electronic equipment onboard seagoing vessels frequently needs a very durable and reliable shock and vibration dampening system to function properly. Many approaches have been tried over the years to provide a mounting system for increasingly complex electronic systems that will allow them to survive under severe shock and vibration conditions that might be encountered aboard a seagoing ship. Some of these systems have worked quite well, but all of them have had drawbacks, including high costs, large amplitude and potentially dangerous swaying, intrinsically unsafe isolation components, and/or unpredictable long-term performance.

Furthermore, many of these existing shock- and vibration-absorbing devices are quite complex and rely on an intricate assembly procedure with a high degree of dependence on operator skill to function correctly. Often these devices are not satisfactory because the devices do not perform as predicted by the manufacturer. The long-term survivability of these devices in actual service appears suspect, as well, because of their complexity and assembly requirements.

A new shock and vibration absorption system employing a better, simpler, and cheaper method of controlling shock and vibration would be advantageous. For example, it would be desirable that a system meet the need for a highly reliable, yet inexpensive mounting system for commercial off-the-shelf (COTS) and custom electronic systems. Such a new system preferably should be compact (having a small footprint), not potentially dangerous to support personnel and have the ability to attenuate shock and vibration to a survivable level for a variety of needs and equipment, such as COTS equipment.

### SUMMARY OF THE INVENTION

The present invention relates to a shock and vibration absorption system and method including a first support device, a second support device, and a plurality of elastic members between the first support device and the second support device that undergo compression to attenuate shock and vibration. The first and second support devices can be the same or different. This system and method can be used in a wide variety of applications.

An exemplary embodiment of the present invention may be implemented in shock- and vibration-absorbent shelving, such as for electronic equipment onboard seagoing vessels, land vehicles, and aircraft. The present invention represents a significant improvement over the existing shock and vibration control devices, especially those used in a vertical-only mounting system, while dramatically reducing the cost of the system and shelving.

A specific implementation of an exemplary embodiment of the present invention may include shock- and vibration-absorbent shelving incorporating an outer structure, corner posts fixedly attached to interior corners of the outer structure, vertical sliding rails slidably engaging the corner posts, an inner structure within the outer structure fixedly attached to the vertical sliding rails, and two shock and vibration attenuation assemblies vertically positioned on either side within the outer structure and between the inner structure and the outer structure. Each shock and vibration attenuation assembly may include the shock and vibration absorption system, having the first and second support devices embodied in a first plate assembly and a second plate assembly, respectively, and having elastic members in the form of elastic tubes between the plate assemblies, and a primary positioning system working in unison to dampen shock and vibration pulses. Within this embodiment of the shock and vibration absorption system, the first plate assembly is attached to the outer structure and the second plate assembly is attached to the inner structure. The primary positioning system may include two side gas springs bracing the first and second plate assemblies. In operation, the shelving system may house, for example, custom or commercial off-the-shelf (“COTS”) electronic equipment that may be mounted in the inner structure. When subjected to external shock or vibration pulses, the inner structure may move upward and downward relative to the outer structure as the vertical slide rails slide along the corner posts, compressing the elastic tubes of the shock and vibration absorption system as the second plate assembly adjusts relative to the first plate assembly.

### BRIEF DESCRIPTION OF THE DRAWINGS

FIGS. 1A-1F show a shock and vibration attenuation assembly, a first plate assembly, a second plate assembly, and a gas die spring of an exemplary system according to an embodiment of the present invention.

FIGS. 2A-2C show parts of a disassembled first plate assembly of an exemplary system.

FIGS. 3A-3B show parts of a disassembled second plate assembly of an exemplary system.

FIGS. 4A-4F show exemplary shock- and vibration-absorbent shelving according to an embodiment of the present invention.

FIGS. 5A-5H show exemplary components of a track system according to an exemplary embodiment of the present invention.

FIG. 6 shows a compression compartment according to an exemplary embodiment of the present invention.

Other features and advantages of the present invention will be apparent from the following description of the exemplary embodiments thereof, and from the claims.

### DETAILED DESCRIPTION

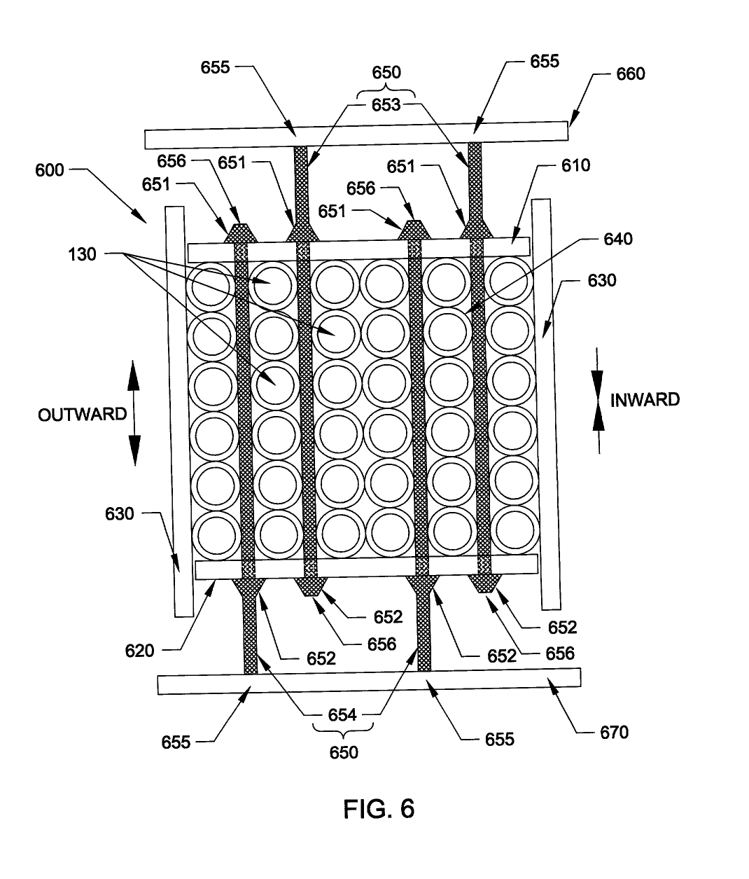

A shock and vibration absorption system includes a first support device, a second support device, and a plurality of elastic members arranged within one or more cavities or spaces formed between the first support device and the second support device. A schematic representation of the present invention is shown in FIG. 6 as a compression compartment 600, discussed later in greater detail. External shock or vibration compresses the elastic members as the first support device and the second support device adjust relative to each other. Compression of the elastic members attenuates the shock and vibration. The system may be used in a wide variety of applications, either alone or in combination with positioning systems or other shock and vibration absorption mechanisms and methods.

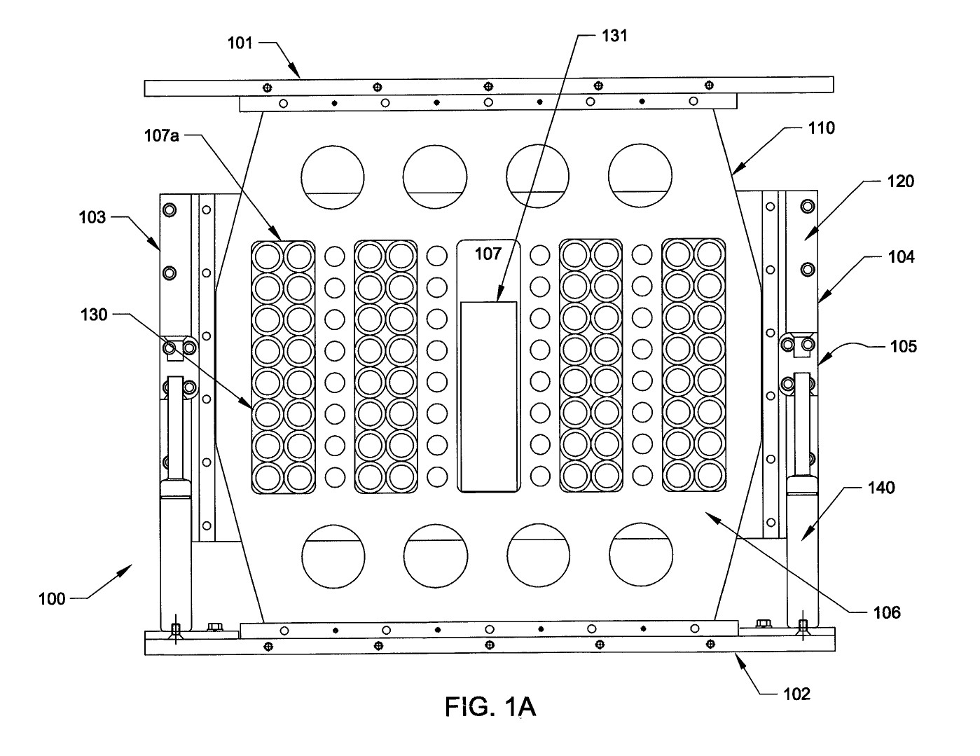

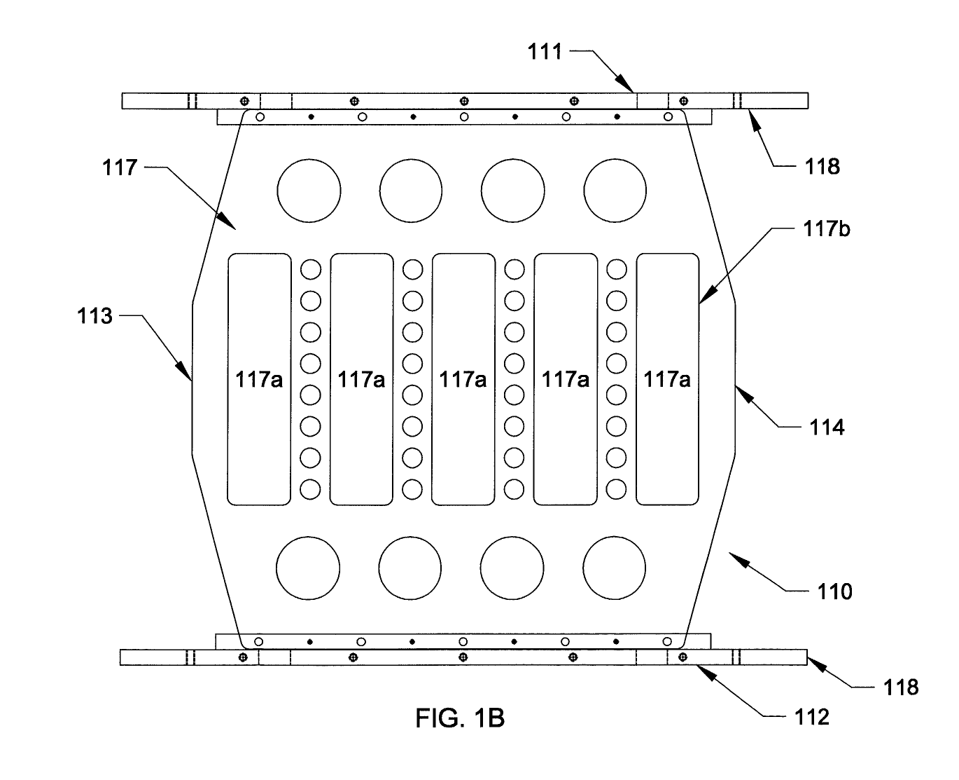

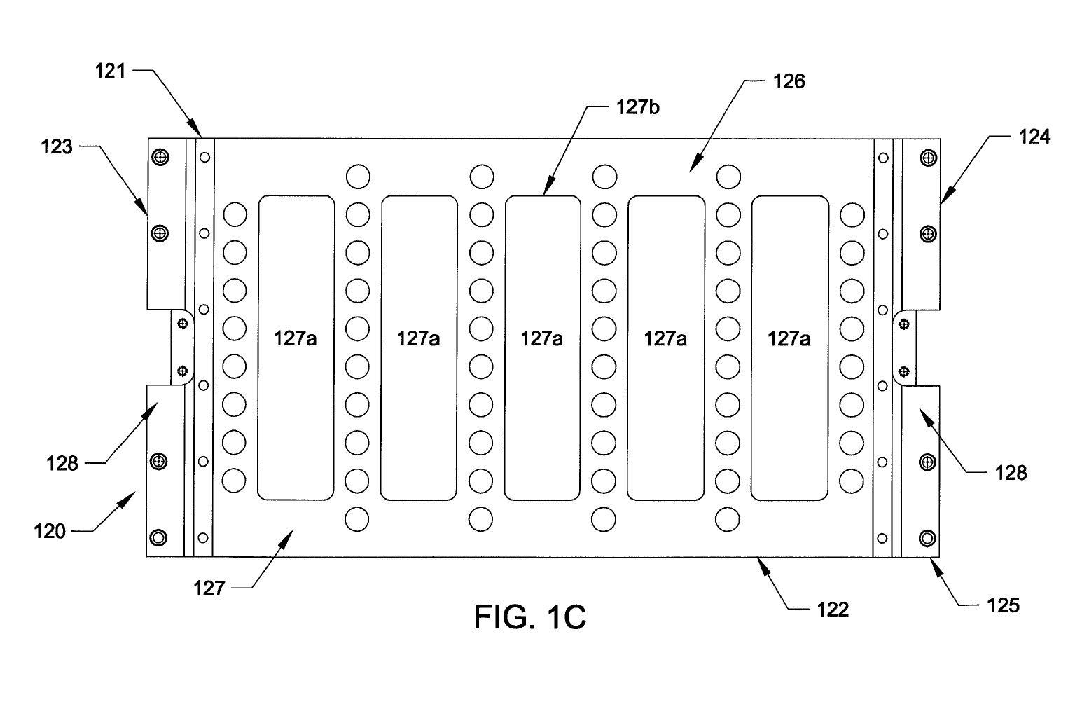

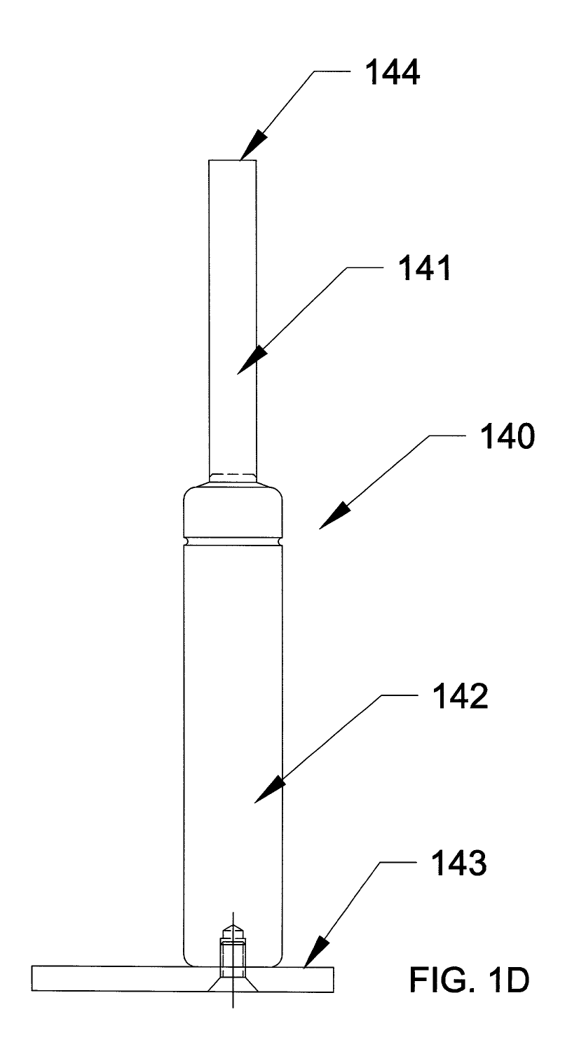

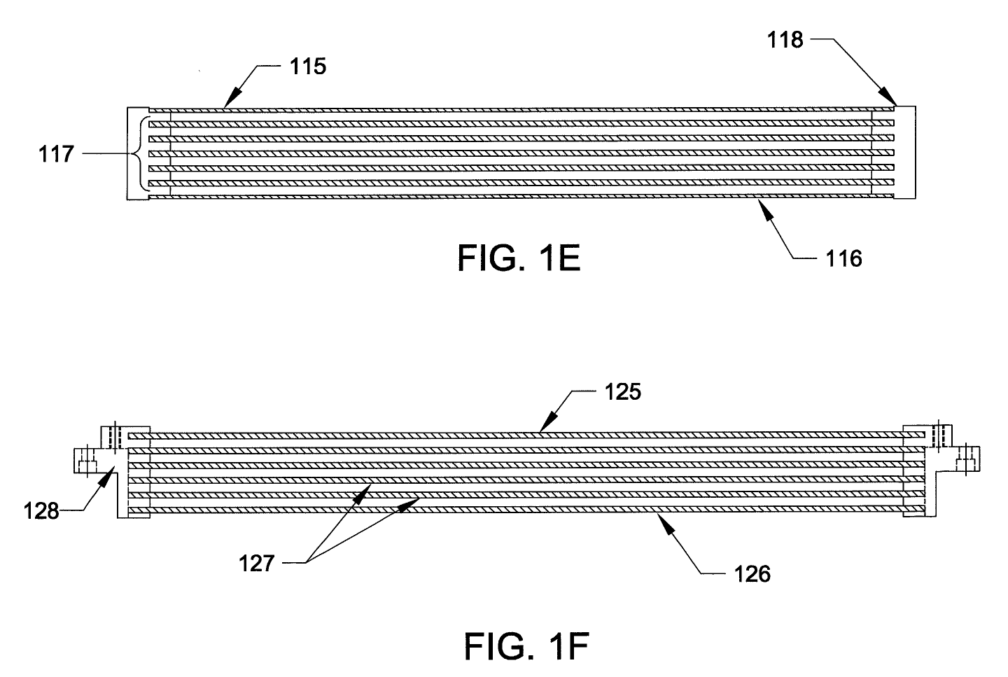

Referring to FIGS. 1A-1F, the shock and vibration absorption system is embodied in a shock and vibration attenuation assembly 100 that is shown having a first support device in the form of a first plate assembly 110, a second support device in the form of a second plate assembly 120, and a plurality of elastic members in the form of elastic tubes 130. As viewed from the perspective of FIG. 1A, the shock and vibration attenuation assembly 100 is shown as it may appear when looking at it from the right, outer side. The embodiment of the shock and vibration attenuation assembly 100 as shown has a top edge 101, a bottom edge 102, a front edge 103, a back edge 104, an inward face 105 (the backside in FIG. 1A), and an outward face 106. A plurality of spaces in the form of tunnels 107 are formed in the assembly 100 in which the tubes 130 are positioned.

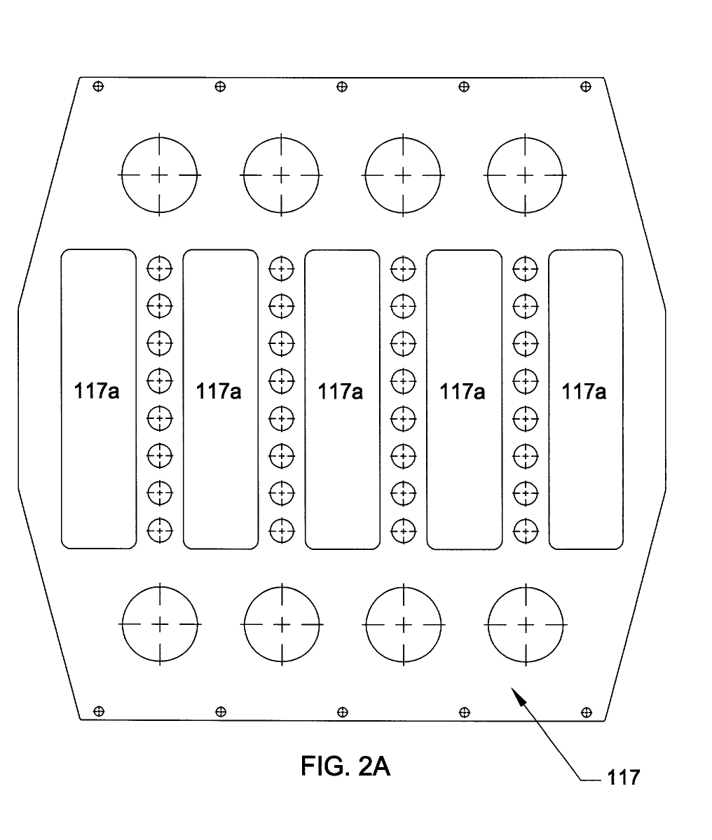

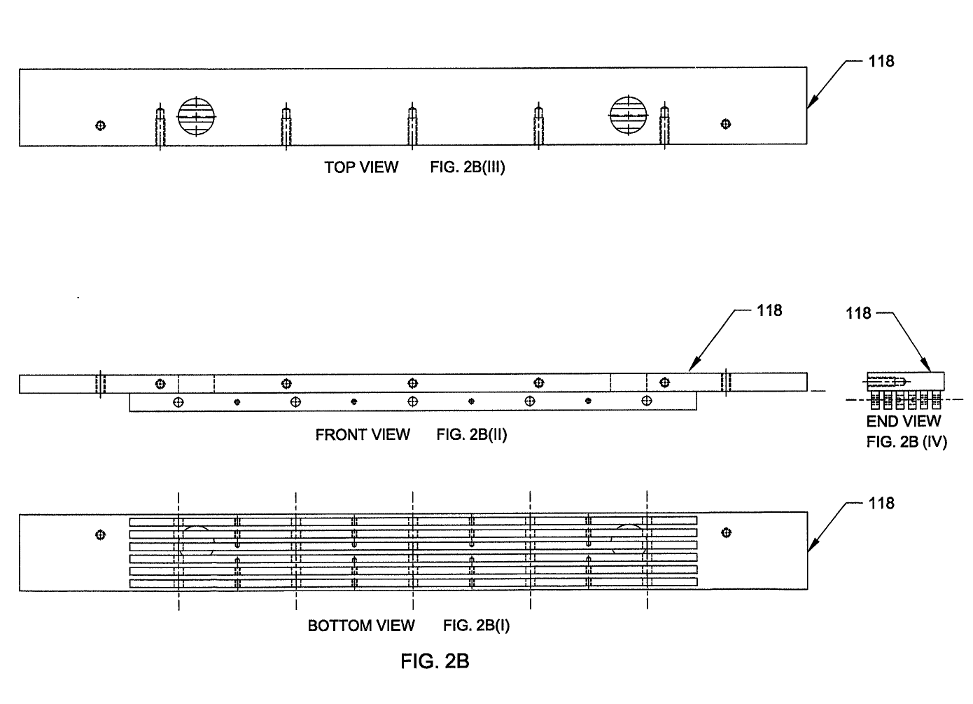

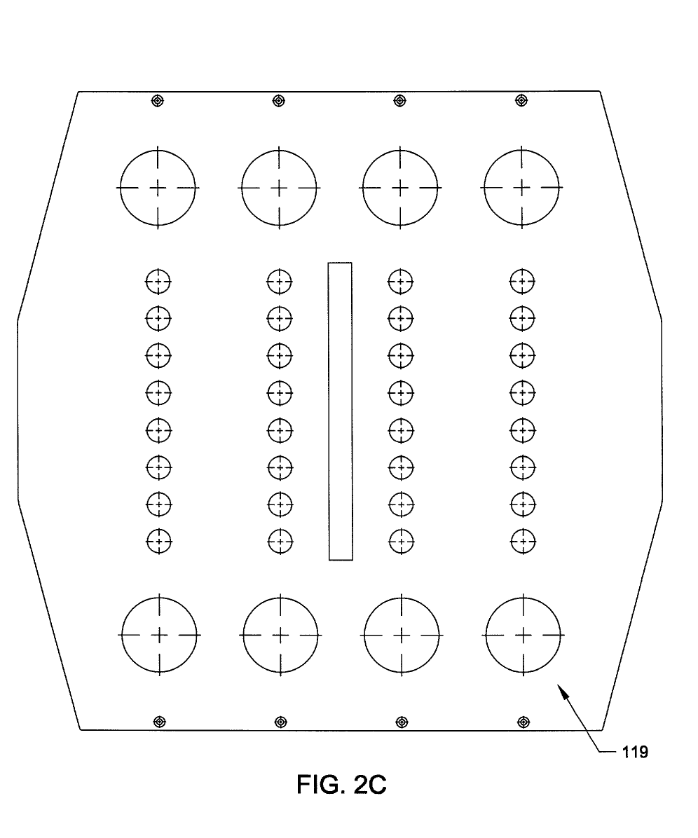

As shown in FIGS. 1B, 1E, 2A-2C, and 4D, the depicted embodiment of the first plate assembly 100 has a top edge 111, a bottom edge 112, a front edge 113, a back edge 114, an inward face 115 and an outward face 116. The first plate assembly 110 includes a plurality of first pocket plates 117, two first plate fans 118, and two first end plates 119. The first plate fans 118 are attached at the top edge 111 and at the bottom edge 112 to the plurality of first pocket plates 117. The first pocket plates 117 include openings that act as first pockets 117a. The first end plates 119 bound the shock and vibration attenuation assembly 100 at the inward face 105 and the outward face 106.

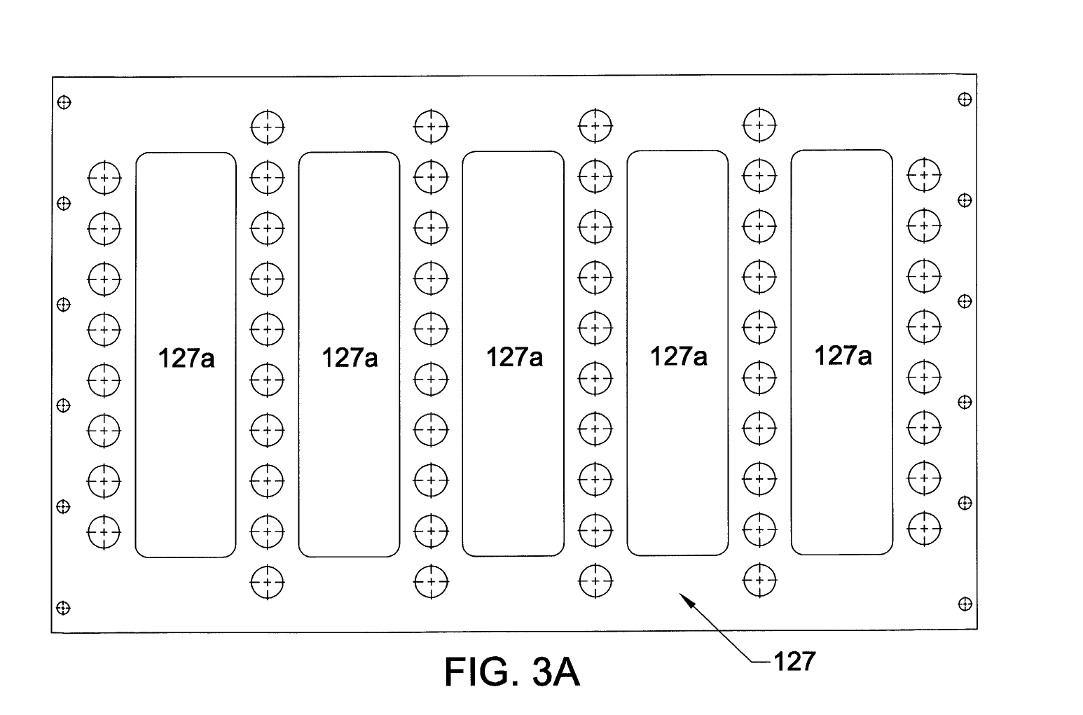

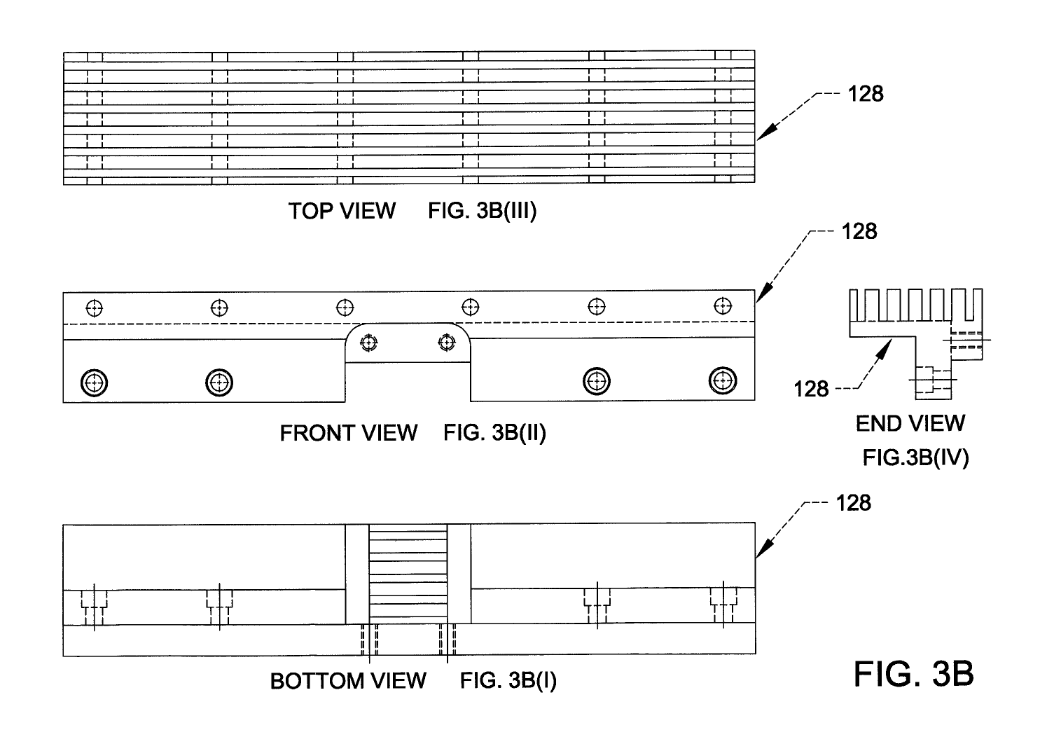

Likewise, as shown in FIGS. 1C, 1F, 3A, 3B and 4D, the depicted embodiment of the second plate assembly 120 has a top edge 121, a bottom edge 122, a front edge 123, a back edge 124, an inward face 125 and an outward face 126. The second plate assembly 120 includes a plurality of second pocket plates 127 and two second plate fans 128. The second pocket plates 127 include holes that act as second pockets 127a. The second pocket plates 127 are arranged in-between the plurality of first pocket plates 117, so that a second inward face 125 faces a first outward face 116, and a second outward face 126 faces a first inward face 115. With the second pocket plates 127 positioned among and between the first pocket plates 117, the second plate fans 128 are attached at the front edges 123 and at the back edges 124 of the second pocket plates 127.

The first and second support devices may take the more particular form and structure of a first and second plate assembly, a first and second cavity-forming assembly, a first and second containment means, or a first and second support means. Equivalents to the support devices, plate assemblies, cavity-forming assemblies, containment means, and support means are determinable by those of ordinary skill in the art and are subject to design choices within the skill in the art appropriate for particular implementations.

The first and second support devices, including the first and second plate assemblies 110 and 120 shown in the figures, may be the same. The first and second support devices, including the first and second plate assemblies 110 and 120 shown in the figures may, be made of any suitable material, including among others, aluminum, steel, titanium, rigid plastic, wood, metal alloys, etc. Each of the first and second support devices may be in the form of a unitary component or an assembly of multiple components. The first and second support devices, including the first and second plate assemblies 110 and 120 shown in the figures, need not be made of the same material or materials. The first and second support devices may take any suitable form and shape, such as plates, boxes, cylinders, other multi-sided structures, that permit them to function in accordance with the invention described herein and include at least one cavity or space in which the elastic members may be fit. Components of the first and second support devices, including the first and second pocket plates 117 and 127 shown in the figures, may be held together with any suitable device substitutable for the plate fans 118 and 128. For example, the pocket plates 117 and 127 may be integrally formed with plate fans 118 and 128 so that the first or second plate assembly 110 or 120 is a single member.

In the embodiment shown in FIGS. 1-3, once the second pocket plates 127 and the first pocket plates 117 are secured by the second plate fans 128 and the first plate fans 118, respectively, the second pockets 127a are aligned with the first pockets 117a, and the plurality of elastic tubes 130 are arranged in the tunnels 107 created by the alignment of the first pockets 117a and the second pockets 127a. A solid stop 131 instead of elastic tubes 130 may be arranged in one of the tunnels 107 to delimit the absolute distance that the shock and vibration attenuation assembly 100 will compress the elastic tubes 130. The solid stop 131 prevents the second top edge 121 from contacting the first plate fan 118 attached to first top edge 111 and prevents the second bottom edge 122 from contacting the first plate fan 118 attached to first bottom edge 112. The solid stop 131 maybe omitted if the elastic tubes 130, when completely compressed, do not permit the second plate assembly 120 to contact the first plate assembly 110. Alternatively, the solid stop 131 may be replaced with one or more detents (not shown) arranged on the first plate assembly.

The plurality of elastic members, which may be in any suitably shaped form, such as tubes or cavernous members, may be made of any suitably elastic material, natural or synthetic, that may compressed and substantially recover size and shape after deformation. Exemplary suitable materials include, among others, rubbers, polymers, plastics, polyurethanes, polyvinyls, polyethylenes, polypropylenes, and co-polymers of these and other materials. The material may be selected so as to tailor the properties of the material to the anticipated embodiment and conditions of use. Moreover, additives, coatings or treatments may be used with the selected material so as to address a specific issue relevant for a particular embodiment. For example, a coating may be used that would prevent oxidation and discoloration of the elastic material. Selection of the material and any additives, coatings and treatments would depend on the implementation of the invention.

Although a plurality of elastic tubes preferably are used in the present invention, any member or members of elastic material may be used that properly fill the cavities or space created by the first and second support devices, such as the tunnels 107 shown in FIG. 1A. For example, one or more specially-made, rectangular parallelepipeds of elastomer having, for example, an interior honeycomb lattice may fill each tunnel 107 instead of a plurality of elastic tubes. Analogously, a tunnel-shaped member of elastic foam may be used. Alternatively, other shapes and sizes of elastic material may fill each tunnel. Preferably, the shape and size of the elastic members yield filled tunnels having uniform resistance and compressibility. Elastic tubing is preferable, however, because it is widely available in a variety of sizes and thicknesses, and is very economical.

Moreover, the design choice of an elastic member may be extrapolated to include compressible mediums, such as pressurized gases, that have elastic responses to stress. The first and second support devices may be characterized as first and second containment means, forming at least one contained cavity between them. As the first and second containment means move relative to another and the volume of the at least one contained cavity decreases, the internal pressure of a gas would increase, as may the temperature, roughly according to the ideal gas law (PV=nRT). Gels or liquids may also be used as compressible mediums, but the maximum compression may be limited to a small percentage of the initial volume. Though, the design requirements necessary to pressurize the contained cavity might cause a significant increase in the relative cost of final product, favoring the use of low-cost elastic tubing.

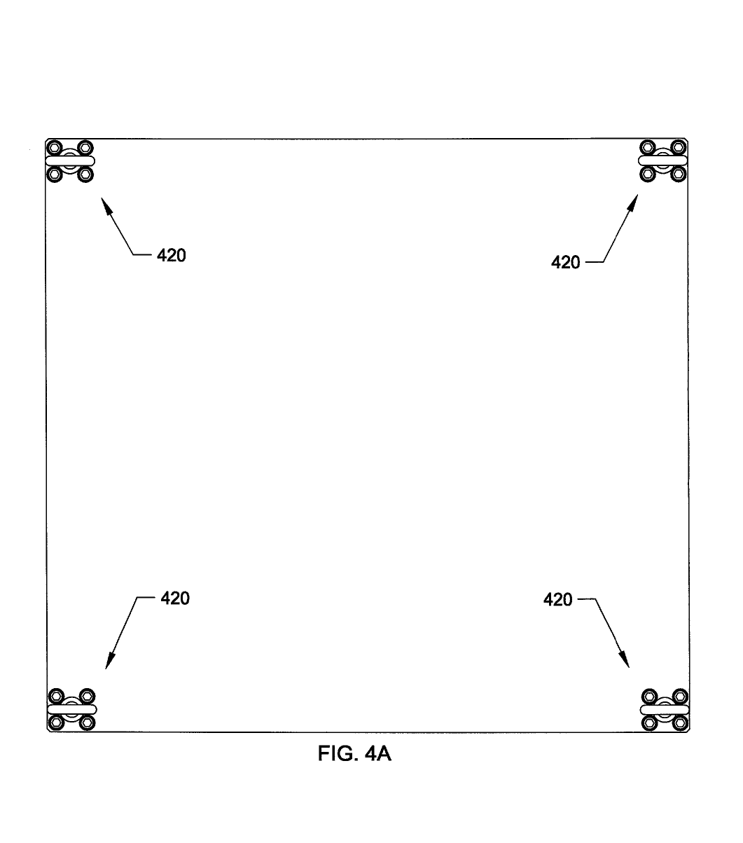

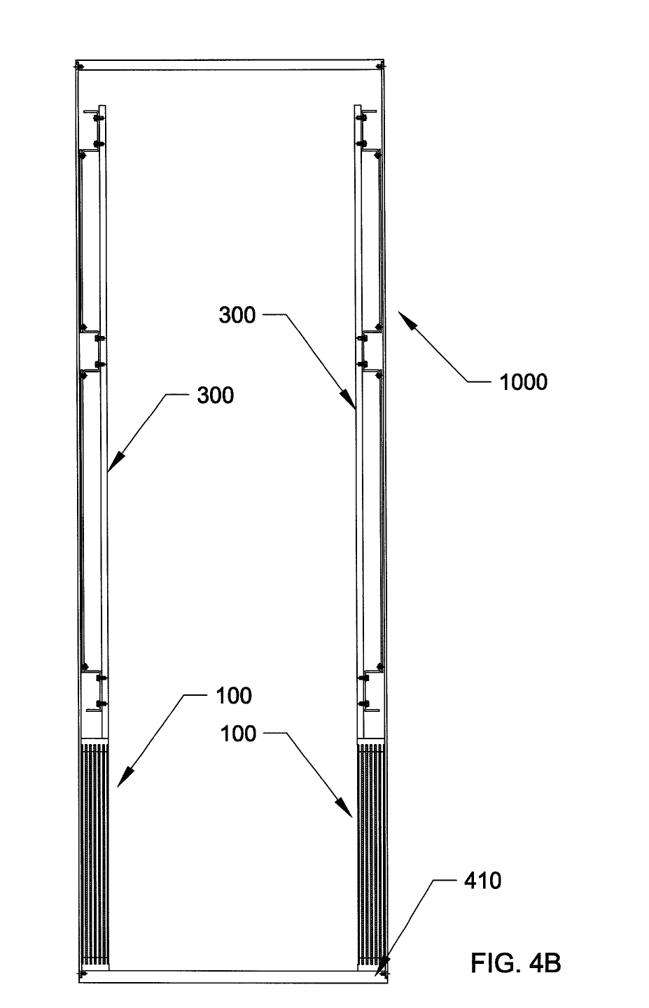

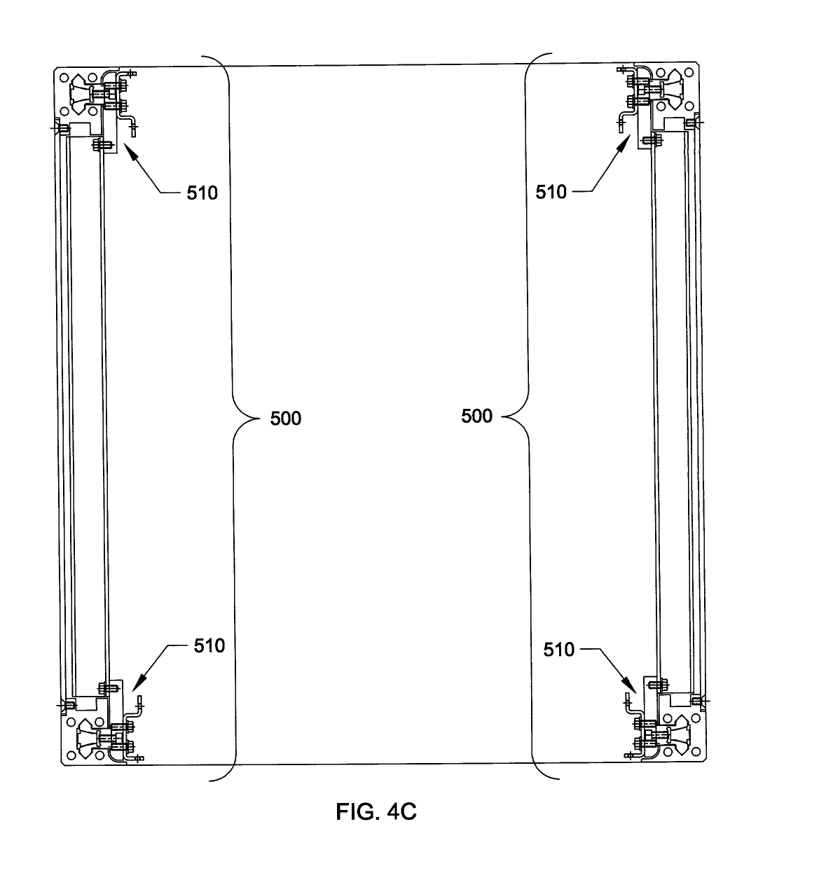

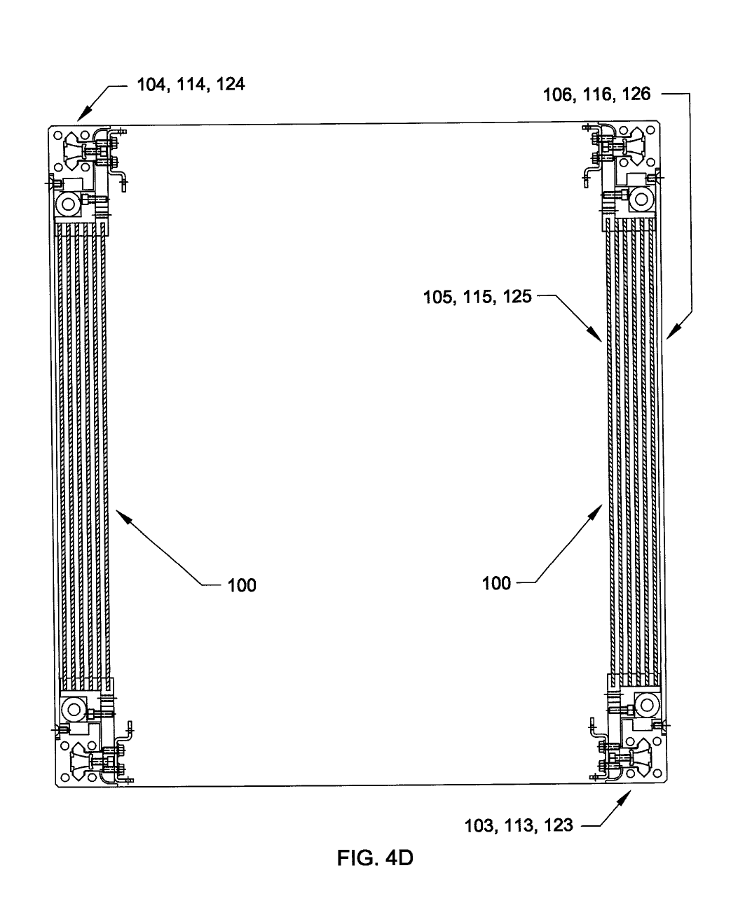

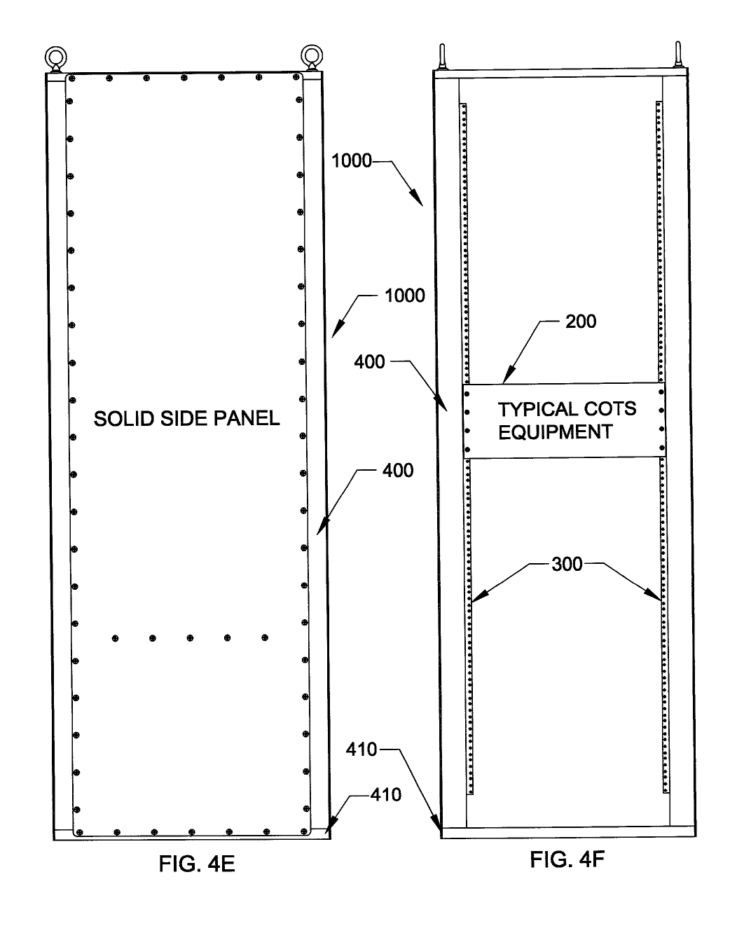

Referring back to FIG. 1A, after the plurality of elastic tubes 130 and the solid stop 131 of this embodiment have been inserted, the first end plates 119 may be arranged on the inward face 105 and the outward face 106 of the shock and vibration attenuation assembly 100. At this point, the second plate assembly 120 is braced by the plurality of elastic tubes 130 against the first plate assembly 110. The elastic tubes 130 are compressed slightly during insertion so as to create a tight fit between the first plate assembly 110 and the second plate assembly 120. With the first end plates 119 in place, the shock and vibration attenuation assembly 100 becomes portable and operable. Upon the attachment of the first plate assembly 110 to a secure bottom 410 (see FIG. 4B) and the attachment of the second plate assembly 120 to shock- and vibration-sensitive equipment 200 (see FIG. 4F), the shock and vibration attenuation assembly 100 will dampen shocks and vibrations arriving at the secure bottom 410 and travelling through the attenuation assembly 100 to the shock- and vibration-sensitive equipment 200. A more detailed description of how the shock and vibration attenuation assembly 100 functions appears later in the specification.

The shock and vibration attenuation assembly 100 preferably also may include a positioning system or other shock and vibration absorption device, such as preloaded nitrogen gas die springs 140. The gas die springs 140 share similarities with gas springs commonly used to hold up hoods and hatches on many different automobiles, although gas die springs 140 are preferably of higher quality and complexity. The die spring 140 is basically a piston 141 in a cylinder 142 that is pressurized with nitrogen gas (not shown) to a pressure that forces the piston rod 141 out of the cylinder 142 until it reaches a hard stop at an end of the cylinder, which limits its travel. The pressure it takes to force the piston rod 141 back into the cylinder 142 is a function of the gas pressure inside the cylinder 142. The nitrogen gas spring 140 will remain fully extended until the force applied exceeds the preload force. At that point, the piston rod 141 begins to retract into the cylinder 142, and with a relatively small increase in force, will retract completely.

Any conventional, coiled spring device generally will deflect almost linearly from its static, zero-force position as force is applied, up to the “stack height” of the spring. Under a given load, the conventional spring will deflect a given amount, depending upon its physical characteristics, which include coil diameter, wire diameter, winding pitch, and material, among others. If an acceleration force is applied to the load supported by a conventional spring, the total force (gravity plus or minus acceleration force) will be counteracted by the spring, which will change its length and thus reposition the supported mass. If a conventional spring were used to position the equipment 200 in the present system, as is common in prior art systems, the position would change with the mass of the loaded equipment and be free to move up and down in response to vertical vibration inputs. But by using a nitrogen gas die spring with sufficient pre-load, the present system can control the precise position of the equipment 200, which will remain fixed with variable loading (+/−25% of the design load) and vertical vibration inputs up to 1G.

Traditionally, shock- and vibration-isolation systems have used special damped springs made from wire rope or elastomer materials. These systems respond to the physics of a spring-isolated mass in that they have a resonant frequency which, because of other design considerations, generally falls within the range of frequencies encountered in the natural environment. When a spring-isolated mass is excited by external oscillations at given amplitudes over a range of frequencies, it typically will oscillate at the input frequency with an output amplitude that is roughly equivalent to that of the input oscillation, so long as the frequency of the input oscillation is several octaves below the resonant frequency.

As the input frequency approaches the resonant frequency, the output amplitude of the spring-isolated mass oscillation increases and typically reaches 3 to 7 times the input amplitude at resonance. This increase is reflected in the Transmissibility Ratio (TR), which equals the output amplitude divided by the input amplitude. As the input frequency exceeds resonance, the output amplitude decreases significantly and, at several octaves above resonance, is damped almost completely. This uneven increase in vibration output amplitudes at or near resonance, i.e., a TR of 3 to 7, has proved to be a substantial problem with these traditional systems. One advantage of the present invention is that the shock and vibration absorption system confines the TR as close to 1 as possible over the entire vibration frequency spectrum, in part by constraining the equipment 200 as much as possible.

In the event that the second plate assembly 120 of this embodiment is attached to shock- and vibration-sensitive equipment 200 having a significant weight relative to the weight necessary to compress the elastic tubes 130, then the shock and vibration attenuation assembly 100 may need to have a preload buffer so as to place the shock- and vibration-sensitive equipment 200 in a state of neutral buoyancy relative to the attenuation assembly 100. This permits the attenuation assembly 100 to be sensitive to the marginal shocks and vibrations without having the elastic tubes 130 continually bear the whole weight of the shock- and vibration-sensitive device. The gas spring's 140 function in the present invention is to hold the second plate assembly 120 in a practically static vertical position relative to the first plate assembly 110 under vibration, but under shock, the piston 141 will collapse and transfer the load to the elastic tubes 130.

In an exemplary embodiment of the present invention, two preloaded nitrogen gas die springs 140 per shock and vibration attenuation assembly 100 accomplish the primary vertical positioning and constraining. A base 143 of each spring 140 is attached to each corner of the first plate fan 118 attached to the first bottom edge 112, while a top 144 of each spring 140 is attached to the second plate fan 128 attached to the second front and back edges 123 and 124. The springs 140 therefore comprise part of the overall shock and vibration attenuation assembly 100. Nonetheless, the primary positioning system may be arranged anywhere where it can serve its function, for example, a gas die spring 140 may be arranged within a tunnel 107, resisting compression of the tunnel 107.

The gas springs 140 can be manufactured with any desired stroke and preload force. The stroke and preload force will largely be determined by the weight to be supported and the shock and vibration to be withstood. For example, as shown in FIGS. 4B and 4D-4F, using two attenuation assemblies 100 for a total of four springs 140 to stabilize equipment 200 mounted in a frame 300 suspended within a cabinet 400, and trying to overcome both gravity and vertical vibration forces up to 1 G, one may select a die spring 140 with a minimum preload force of ½ the loaded weight of the frame 300. This scenario yields a total upward force of at least 2 times the total weight of the mounted equipment 200 which will support the equipment 200 even under 1 G of vertical vibration acceleration. The weight of the equipment 200, coupled with the added centering forces created by the attenuation assembly 100, is adequate to limit the upward component of vertical vibration. Under extreme conditions or where the vibration requirements exceed 1 G, four additional gas springs 140, working in the opposite direction, can be added to further constrain the equipment 200 from unwanted motion.

To better understand the sorts of conditions in which the present system is designed to operate, it is useful to describe some of the testing to which a shock- and vibration-isolation system may be subjected to verify the integrity of the system and overall design. For example, systems designed for use aboard military ships typically undergo vibration testing in the three linear axes over frequencies ranging between 3 Hz to 50 Hz at input amplitudes of slightly less than 1 G. The frequencies are designed to simulate vibrations encountered aboard ships having a variety of propellers and number of propeller blades, operating at propeller shaft speeds likely encountered on a broad range of ships. A frequency sweep typically is performed for each linear axis to determine the resonant point(s) and then the system is tested for 2 hours or so at the resonant point(s).

In addition, systems for use aboard naval ships typically are shock tested. Previously, a special “medium weight hammer” test machine was used to generate shocks, but recently “heavy weight barge” testing has become common. Simulating a combat environment, an underwater explosion is detonated a few yards away from a special heavy weight steel barge secured in the middle of a deep lake or quarry and to which the system is mounted. The explosion generates a very large shock pulse, up to 150 G for a few milliseconds, that is transmitted directly to the system being tested. The present system is designed to attenuate this shock pulse sufficiently so as to allow mounted equipment 200 to survive and continue to function. In this context, the resistance of the nitrogen gas die spring 140 is quickly overcome by the magnitude of the shock pulse.

FIGS. 4A-4F depicts an exemplary embodiment of the present invention implemented within dual-structure, shock- and vibration-absorbent shelving 1000. A major advantage of this implementation as compared with conventional shelving designs is the use of a hybrid system with separate elements, rather than the use of a single device, to control shock and vibration. As mentioned above, the cabinet 400 acts as an outer structure that encloses the frame 300, which is suspended atop the shock and vibration attenuation assemblies 100. The frame 300 is an inner structure in which the equipment is mounted. The frame 300 is suspended within the ridged, hard-mounted outer cabinet 400 by a track system 500 that constrains the inner frame 300 in all axes except the vertical axis. In the absence of the shock and vibration attenuation assemblies 100, the inner frame 300 is free to move vertically up and down. The extent of this travel is a function of the maximum shock and vibration attenuation that the shelving 1000 must supply. Typically, this is around plus and minus 2 inches to achieve adequate attenuation to protect COTS equipment aboard a ship.

Track System

Several varieties of tracks and rails are known in the art to permit motion limited to one axis, and almost any of these may be used to support the frame 300. However, the shelving 1000 implementation of a preferred embodiment of the present invention may use the track system 500 described below. Preferably, the track system 500 should allow movement in only the vertical x-axis and be constrained in the other 5 of 6 directional axes (the linear horizontal y-axis and spatial z-axis, and the rotational axes about the x-axis, y-axis, and z-axis). The track system 500 may include four tracks 510 that may be arranged in four comers 420 of the cabinet 400. As shown in FIG. 4A, the cabinet 400 may have a roof on which hoisting loops (cf. FIG. 4E) are secured in each corner 420 to the tracks 510 beneath them, to permit the cabinet to be more easily moved. Each track 510 may exhibit complete vertical symmetry (see FIG. 4C), as may each of the track components, so that an assembled track 510 preferably may be used at any of the 4 corners, after appropriate rotation of the track 510.

Ideally, an inexpensive, rugged, yet precise linear slide system is desired to effect the overall design of the enclosure system. Track system 500 was developed to meet the exacting requirements of a COTS-equipment shelving system for use in naval vessels, providing functionality at a minimal cost. The design of the track system 500 would have use in any application where a precision, yet relatively low cost linear travel system is needed.

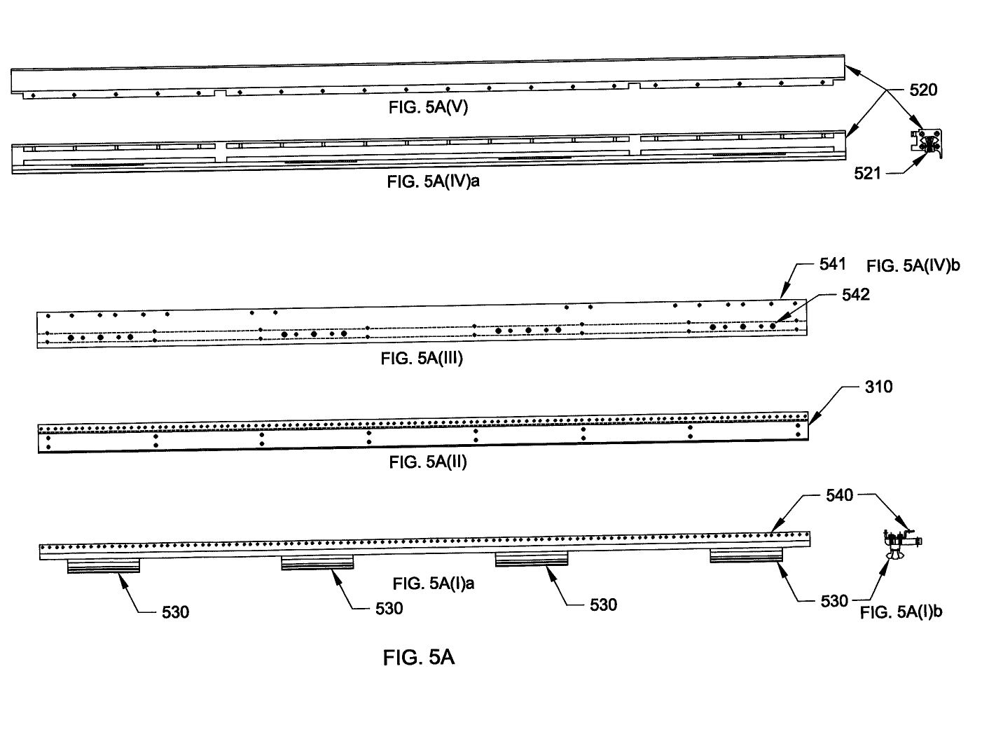

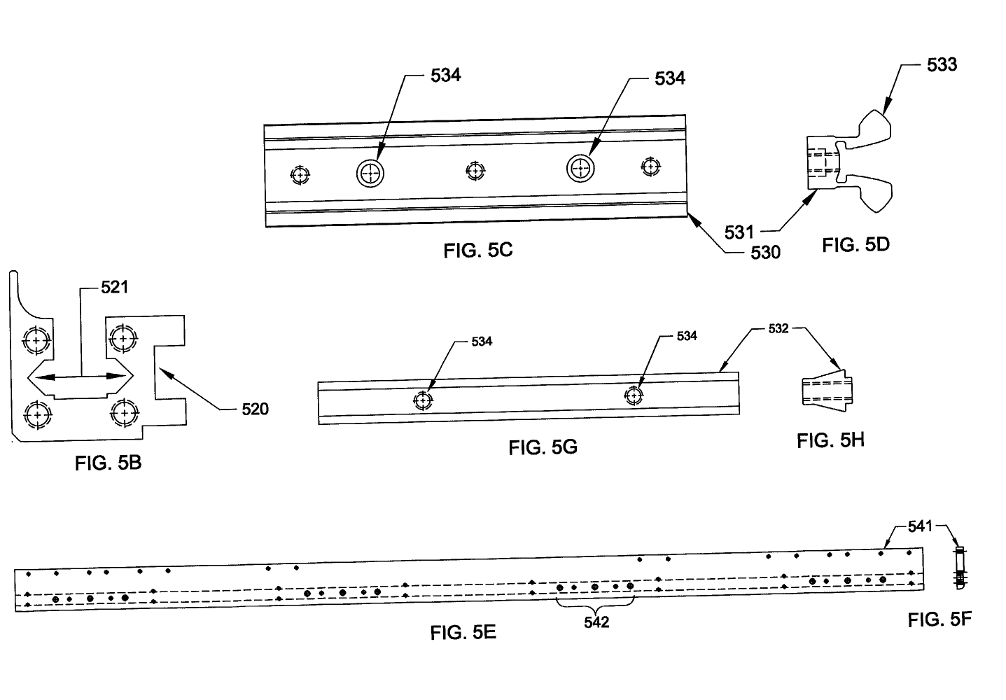

As shown in FIGS. 5A-5H, each track 510 may include a corner post 520, a plurality of truck assemblies 530, and a vertical slide rail assembly 540. FIGS. 5A(I)a and 5A(I)b depict an assembled vertical slide rail assembly 540 from a side view and an end view, respectively, whereas FIGS. 5A(II) and 5A(III) depict possible components thereof. FIGS. 5A(IV)a and 5A(IV)b show the corner post 520 from a front view and an end view, respectively, whereas FIG. 5A(V) shows the corner post 520 from above, relative to FIGS. 5A(IV)a and 5A(IV)b. The truck assembly 530 interfaces the vertical slide rail assembly 540 with the corner post 520, as shown in FIG. 4D. The corner post 520 may be fixedly attached to the cabinet 400 and the first plate assembly 110, whereas the vertical slide rail assembly 540 is fixedly attached to the frame 300 and the second plate assembly 120.

Each corner post 520 of this implementation may include an inner groove 521, having a roughly T-shaped cross section, as shown in FIG. 5B, the cross of the T within the interior of corner post 520 and the base of the T forming an opening to the exterior of the corner post 520. One or more of the truck assemblies 530 may be inserted into the inner groove 521. A truck assembly 530 may include a truck 531 and a truck adjuster 532. As shown lengthwise and endwise, respectively, in FIGS. 5C and 5D, the truck 531 may have flexible wings 533 that snap into the T-shaped inner groove 521. The truck adjuster 532, as shown lengthwise and endwise, respectively, in FIGS. 5G and 5H, is inserted between the wings 533 so as to expand the wings 533 and eliminate unwanted space between the truck assembly 530 and the groove 521. More generally, the groove 521 may have angular sides and be wider at the interior than at its opening to the exterior, while the cross-section of the truck assembly 530 complements the cross-section of the groove 521. The wings 533 of the truck 531 may therefore have angular mating surfaces that mate against the angular sides of the groove 521.

The vertical slide rail assembly 540 may then be attached to the truck assemblies 530 within a corner post 520. The vertical slide rail assembly 540 may include one or more rail components 541, such as shown in FIGS. 5A, 5E and 5F, that combine to provide structural support and attachment versatility to the vertical slide rail assembly 540. One of the rail components 541 may include an equipment mounting rail 310 (see FIG. 5A(II)), to which equipment 200 may be attached. The truck adjusters 532 also adjust the level of resistance necessary to slide the vertical slide rail 540. Preferably, the vertical slide rail 540 may slide up and down without much resistance.

The internal frame 300 of this implementation preferably is attached to four tracks 510, one per corner 420, and each track preferably has four truck assemblies 530 that ride along the groove 521 in each corner post 520. The truck assemblies 530 preferably are symmetrical and self-centering. One benefit of the truck assemblies 530 being self-centering is that mounting holes 534 and 542 used to attached the truck assemblies 530 to the vertical slide rail assembly 540 are always maintained in perfect alignment. Use of the truck adjusters 532 preferably allows each truck 531 to be adjusted for zero lash in the precise area of the groove 521 where it travels. After adjustment, the four truck assemblies in each corner post 520 preferably are fastened to the rugged main vertical slide rail assembly 540 that supports the equipment-mounting rail 310. To the extent that the housing of equipment 200 is bolted directly to equipment-mounting rail 310, rail 310 may act as the frame 300.

To improve the functionality and longevity of the tracks 510, the tracks 510 may be treated with protective lubrication processes. For example, the corner posts 520 may be treated with a standard chromate conversion process in the area of the groove 521, while the trucks 531 may be anodized and then treated with a resin bonded molybdenum disulfide extremely high pressure dry lubricant coating to assure free movement, even after years of inactivity. The zero lash vertical track system 500 in each corner post produces a Transmission Ration (TR) of about 1 across the vibration spectrum in the 5 constrained axes. The 6^{th} or vertical axis would be free to move in the absence of gravity and the contribution of the first element of our hybrid vibration control system.

It is worth noting a few of the advantages of the novel track system 500 used in the present COTS-equipment shelving system 1000. Critical space limitations aboard naval vessels made existing track systems undesirable because they were not designed to be both rugged and precise, while occupying little space. It is therefore advantageous that track system 500 may be integral to the structure of the corner post 520. This integral design occupies little space while providing strength and precision.

Historically, a common method of reducing costs is to make a product within normal production tolerances, and precision (zero lash or movement in any axis other than the travel axis) is often achieved by making the product fully adjustable in every axis. The track system 500 uniquely combines these two techniques. First, to reduce manufacturing cost and complexity, the track system 500 may be machined using standard machine shop tooling.

Preferably, a precision extruder would extrude the corner post 520 and track 510 for production, due to the unique geometry of truck 531 and the truck adjuster 532. Second, the total adjustment of the vertical slide rail assembly 540 is accomplished with a single screw (per unit length) between the truck 531 and the truck adjuster 532, while always keeping the truck 531 centered in the groove 521 of the track 510.

Preferably, the walls of the groove 521 of the track 510 are machined flat at a 45 degree angle to centerline of the corner post 520. The wings 533 of the truck 531 advantageously may have mating surfaces that have a very large radiused (slightly rounded) surface that contacts the walls of the groove 521 at a single point on each of the 4 symmetrical surfaces. By design, the truck 531 preferably may be extruded to be slightly smaller than the groove 521 which allows it to be freely inserted in the end of the corner post 520. The two wings 533 of the truck 531 are wedged outward to contact the corner post 520 by the truck adjuster 532 that is drawn into the tapered slot between the wings 533 by the adjustment screw. Because of the preferred geometry of the truck 531 and the groove 521, the truck assembly 530 is automatically centered in the track 510 and mounting points on the truck 531 remain in a constant position independent of the adjustment of the truck 531. An added unique feature of this design is that the track system 500 has a stability in the rotational axes that is typical of more costly and complicated parallel track systems.

With the track system 500 attached to the cabinet 400, to the frame 300 and to the shock and vibration attenuation assembly 100, the frame 300 is ready to have equipment 200 mounted on it. If loaded, the inner frame 300 system would drop to its lower limit of travel under its own weight in the absence of the gas springs 140 to support it. However, as discussed above, the inner frame 300 system must be able to move both upwards and downwards from some neutral or static position to be able to absorb shock and vibration pulses. This neutral position may be controlled by the two separate systems working in tandem within the shock and vibration attenuation assembly 100.

In particular, the plurality of tubes 130 confined within the plate assemblies 110 and 120 acts as the shock and vibration absorption system of the shock and vibration attenuation assembly 100. The shock and vibration absorption system has a neutral position that it will try to assume in the absence of external forces, including gravity. Gravity, though, applies an unidirectional force on the shock and vibration absorption system, forcing it away from its neutral position. Therefore, the shock and vibration absorption system can only assist a primary positioning system to hold the inner frame 300 in a fixed position under vertical vibration input. With a preload proportional to the weight of a frame 300 loaded with equipment 200, the gas spring 140 operates as the primary positioning system within the shock and vibration attenuation assembly 100. The shock and vibration absorption system and the primary positioning system combine to create a totally unique system for attenuating and absorbing high energy, short duration shock and vibration pulses through use of the shock and vibration attenuation assembly 100.

The present invention provides a shock and vibration isolation system that allows the protected mass to move in response to an initial input in an effort to integrate or extend the duration of the shock and vibration pulse, and thus reduce the peak energy. The system of the present invention also absorbs as much of the energy as possible and converts it, either to some other form of energy that can be dissipated slowly over time, or directly into harmless heat energy. While other assemblies have attempted these feats using more complicated, expensive and unreliable components, the present shock and vibration attenuation assembly 100 accomplishes them with common, low-cost components.

Referring to FIGS. 4B and 4D, two identical shock and vibration attenuation assemblies 100 are shown positioned on a bottom plate 410 on opposing sides of the cabinet 400. With the tracks 510 in each corner 420 of the cabinet 400, the second plate assemblies 120 are attached to the vertical slide rail assemblies 540. Meanwhile, the first plate assemblies 110 are attached to the bottom plate 410 and to the corner posts 520. When a shock pulse (typically a sudden motion with a significant vertical component) is applied to the bottom 410 of the cabinet 400, the inertial mass of the equipment 200 mounted on the inner frame 300 tends to want to stay where it is (Newton's third law). This creates relative motion between the inner and outer structures, i.e., the frame 300 and the cabinet 400, and hence between the first plate assembly 110 and the second plate assembly 120. The relative movement between the second plate assembly 120 and the first plate assembly 110 operates to dampen the shock and vibration in a unique way, as described below.

As discussed with respect to FIGS. 1A-1C, the first and second assemblies 110 and 120 of the shock and vibration attenuation assembly 100 each may include a plurality of nearly-identical, interlaced plates 117 and 127 that are fastened together with the plate fans 118 and 128 that resemble combs. The plates 117 of the first plate assembly 110 are interlaced with the plates 127 of the second plate assembly 120, with some space in between the plates to allow them to move freely relative to each other. The first plates 117 are secured on the top 111 and bottom 112, while the second plates 127 are attached on the front 123 and the back 124. Each plate has a plurality of pockets 117a and 127a, and each pocket 117a, 127a has a perimeter edge 117b, 127b that preferably forms a vertical rectangle. The perimeter edges 117b and 127b line up to form tunnels 107 having tunnel sidewalls 107a. The tunnels 107 may be, for example, roughly 2″ deep, given ⅛″ thick plates, when the second plate assembly 120 is in its neutral position. Insofar as these tunnels 107 are defined by the perimeter edges 117b and 127b of pockets 117a and 127a, the tunnels 107 decrease in size when the inner frame 300 moves either up or down relative to the outer cabinet 400.

In this specific implementation of an exemplary embodiment of the present invention, each tunnel 107 preferably is filled with a plurality of tubes 130 as long as the tunnel 107 that are made of commercially available polyurethane elastic tubing. Though, as discussed above, a variety of elastic materials in many shapes and sizes may be used in the present invention. For example, each tunnel 107 may include 16 tubes of 1″ diameter, ⅛″ wall, and 2″ length. The elastic tubing is initially compressed, preferably about 12%, which creates a slight preload that keeps everything tight and may help to dampen vertical vibrations. When the inner frame 300 moves in either direction relative to the outer cabinet 400 in response to a shock and vibration pulse, the tunnels 107 become smaller and the tubes 130 become deformed. When a force is applied to the top of a tube 130, the tube 130 tries to flatten out and get wider; i.e., downward forces are converted to sidewise forces. When the tunnels 107 become smaller, the deforming tubes apply an ever-increasing force on the perimeter edges 117b and 127b defining the tunnel sidewalls 107a, which are moving relative to the tubes 130. In fact, every second pocket plate 117 is moving in the opposite direction of the first pocket plate 127 next to it, and all pocket plates 117 and 127 are moving relative to the tubes. As the tubes 130 are compressed, the tubes 130 apply force to the sidewalls 107a, and this force generates considerable friction against the sidewalls 107a as they move, converting kinetic energy into heat.

When a force compresses or deforms the tubes 130, a portion of the energy is temporarily stored in the elastomer elements of the elastic tubes. The stored energy creates an opposing force that resists the applied force, until the stored energy is released back into the system when the initial forces are decreased. Some additional energy is converted directly to heat in the deformation process. The compression of the tubes 130 and the resultant friction limit the extent to which the frame 300 travels and quickly attenuate the destructive energy associated with the shock and vibration pulse. Among the several implementation-specific variables, the number of tunnels 107 used and the wall thickness of the elastic tubes can be adjusted to compensate for the total loaded mass of the frame 300.

Because of the elegance of the design, the long-term stability of the components and the absence of any volatile lubrication, the shock- and vibration-absorbent shelving 1000 should be able to function properly under shock and vibration loads after years of normal static deployment. In comparison to competing shelving, the shelving 1000 provides a COTS equipment shelving system with good performance at a relatively modest price. Insofar as the outer cabinet 400 is stationary, the shelving 1000 does not propose a sway hazard to support personnel and requires a minimum amount of space above that needed to house the equipment 200.

Even though the preferred embodiment has been described as including a plurality of first pocket plates 117 and a plurality of second pocket plates 127 positioned next to each other to create the tunnels 107, the present invention may also be embodied by a compression compartment 600 as shown in FIG. 6. Compartment 600 may have two opposing surfaces, a first surface 610 and a second surface 620, separated by a fixed distance, having side surfaces 630 extending from the first surface 610 to the second surface 620 defining a cavity 640 between the first and second surfaces 610 and 620. A plurality of rods 650 traverses the first and second surfaces 610 and 620, each rod 650 having a first brace 651 beyond the first surface 610 outside of the cavity 640 and a second brace 652 beyond the second surface 620 outside of the cavity 640.

The plurality of rods 650 is divided between first surface rods 653 and second surface rods 654, wherein the first surface rods 653 have attached ends 655 secured to a first structure 660 beyond the first brace 651 and free ends 656 terminating beyond the second brace 652. Similarly, the second surface rods 654 have attached ends 655 secured to a second structure 670 beyond the second brace 652 and free ends 656 terminating beyond the first brace 651. Arranged within the cavity 640 is a plurality of elastic tubes or members 130, as described above.

When an inward force, i.e., a force pushing the attached ends 655 of the plurality of rods 650 towards the cavity 640, is applied to the first and/or second structure 660/670, the first braces 651 of the first surface rods 653 push the first surface 610 inward while the second braces 652 of the second surface rods 654 push the second surface 620 inward, thereby compressing the elastic material 130 filling the cavity 640. Conversely, when an outward force, i.e., a force pulling the free ends 656 of the plurality of rods 650 towards the cavity 640, is applied to the first and/or second structure 660/670, the second braces 652 of the first surface rods 653 pull the second surface 620 inward while the first braces 651 of the second surface rods 654 pull the first surface 610 inward, thereby compressing the elastic material 130 filling the cavity 640.

Therefore, inward or outward displacement of the first structure 660 or the second structure 670 will result in compression of the elastic material 130 filling the cavity 640. Compression of the elastic material 130 creates lateral forces against the side surfaces 630, thereby absorbing and attenuating the force causing the displacement, the force potentially being a shock or vibration. Interestingly enough, the absorption and attenuation of a force of a given strength should be constant whether the force is directed inward or outward. Consequently, a more uniform response results regardless of the direction of the force.

Note that the present invention differs significantly from certain conventional methods employed to isolate shock and vibration in that no wire-rope isolators, struts, conventional “shock absorbers”, or similar shock-absorbing devices from the prior art are necessarily used. Nonetheless, such systems or methods may be used in conjunction with this invention to make custom systems or methods tailored to meet specific needs. The present system accomplishes the necessary energy absorption to soften shock and vibration such as that encountered on board seagoing vessels while allowing COTS electronic equipment to survive shipboard environments. Moreover, adaptations of the shock and vibration attenuation assembly 100 may be used, with or without the primary positioning system and the track system 500, in a variety of different contexts requiring either shock and vibration absorption or cushioning, such as in high technology manufacturing equipment and facilities, automobile bumpers, automobile suspensions, athletic facility floors, seat suspensions, weapons, artillery, etc.

A number of embodiments of the present invention have been described above. Nevertheless, it will be understood that various modifications may be made without departing from the spirit and scope of the invention. Accordingly, other embodiments may be within the scope of the following claims. It is intended that all matter contained in the above description or shown in the accompanying drawings shall be interpreted as illustrative and not in a limiting sense. It is also understood that the following claims are intended to cover all of the generic and specific features of the invention herein described and all statements of the scope of the invention, expressed or implied.

What is claimed is:

1. A shock- and vibration-absorbing system comprising:
a first plate assembly attachable to a first structure,
a second plate assembly attachable to a second structure, and
a plurality of cavernous members of an elastic material;
wherein the first plate assembly and the second plate assembly together form at least one cavity having an initial volume in which the plurality of cavernous members are arranged;
wherein, after attachment of the first plate assembly to the first structure and the second plate assembly to the second structure, shock and vibration passing between the first structure and the second structure cause the first plate assembly and the second plate assembly to move relative to each other to reduce the initial volume of the at least one cavity so as to compress the plurality of cavernous members; and
wherein compressing the plurality of cavernous members exerts pressure against the first plate assembly and the second plate assembly so as to absorb the shock and vibration.

2. The system of claim 1, wherein the first plate assembly includes a plurality of first pocket plates, each first pocket plate having at least one hole forming a first pocket, the first pockets of the plurality of first pocket plates overlapping one another so as to form the at least one cavity in conjunction with the second plate assembly.

3. The system of claim 2, wherein the second plate assembly includes a plurality of second pocket plates, each second pocket plate having at least one hole forming a second pocket, the second pockets of the plurality of second pocket plates overlapping one another so as to form the at least one cavity in conjunction with the first pockets of the plurality of first pocket plates of the first plate assembly.

4. The system of claim 3, wherein the first plate assembly includes at least one first plate end attached to the plurality of first pocket plates, and the second plate assembly includes at least one second plate end attached to the plurality of second pocket plates.

5. The system of claim 1 further comprising at least one side surface;
wherein the first plate assembly includes a first surface and the second plate assembly includes a second surface;
wherein the at least one cavity is defined by the first surface, the second surface, and the at least one side surface;
wherein the first plate assembly includes a plurality of first rods, each first rod having an attached end attached to the first structure, a free end terminating beyond the second surface, a first brace arranged outside the at least one cavity towards the first structure and a second brace arranged outside the at least one cavity towards the second structure;
wherein the second plate assembly includes a plurality of second rods, each second rod having an attached end attached to the second structure, a free end terminating beyond the first surface, a first brace arranged outside the at least one cavity towards the first structure and a second brace arranged outside the at least one cavity towards the second structure; and
wherein the first surface and the second surface are free to slide in relation to the plurality of first rods and the plurality of second rods prior to the arrangement of the cavernous members in the at least one cavity.

6. The system of claim 5 further comprising a primary positioning system, the primary positioning system having a first end in contact with the first plate assembly and a second end in contact with the second plate assembly, the first end and the second end pressing against the first plate assembly and the second plate assembly to maintain the initial volume of the at least one cavity;
wherein the primary positioning system providing a preloaded resistance against the first plate assembly and the second plate assembly so as to prevent relative movement between the first plate assembly and the second plate assembly when the primary positioning system experiences shock and vibration weaker than the preloaded resistance.

7. The system of claim 6, wherein the primary positioning system includes at least one nitrogen gas die spring.

8. The system of claim 1, wherein the first plate assembly is made primarily of one of wood, rigid plastic, metal, ceramics, graphite, fiberglass, concrete and stone.

9. The system of claim 1, wherein the elastic material includes at least one of rubber, polyurethane, polyvinyl, polyethylene, and polypropylene.

10. The system of claim 1, further comprising a primary positioning system, the primary positioning system having a first end in contact with the first plate assembly and a second end in contact with the second plate assembly, the first end and the second end pressing against the first plate assembly and the second plate assembly to maintain the initial volume of the at least one cavity;
wherein the primary positioning system providing a preloaded resistance against the first plate assembly and the second plate assembly so as to prevent relative movement between the first plate assembly and the second plate assembly when the primary positioning system experiences shock and vibration weaker than the preloaded resistance.

11. The system of claim 10, wherein the primary positioning system is arranged within the at least one cavity.

12. The system of claim 10, wherein the primary positioning system includes at least one nitrogen gas die spring.

13. The system of claim 1, further comprising a shelving assembly comprising:
an outer structure connected to the first plate assembly,
an inner structure within the outer structure and connected to the second plate assembly, and
wherein the inner structure is suspended by the second plate assembly within the outer structure.

14. The system of claim 13, wherein the outer structure includes a cabinet and the inner structure includes a frame.

15. The system of claim 13, the shelving assembly further comprising a track system between the outer structure and the inner structure.

16. The system of claim 15, wherein the track system includes at least one track, each at least one track having a corner post fixedly attached to the outer structure and a vertical sliding rail attached to the inner structure and slidably engaging the corner post.

17. The system of claim 16, wherein the at least one track includes a plurality of truck assemblies attached to the vertical sliding rail and mounted within the corner post, the plurality of truck assemblies forming an interface between the vertical sliding rail and the corner post.

18. The system of claim 17, wherein each of the plurality of truck assemblies includes a truck and a truck adjuster attached to the truck, the truck adjuster serving to center the truck in the corner post.

19. The system of claim 13, further comprising a primary positioning system, the primary positioning system having a first end in contact with the first plate assembly and a second end in contact with the second plate assembly, the first end and the second end pressing against the first plate assembly and the second plate assembly to maintain the initial volume of the at least one cavity;
wherein the primary positioning system providing a preloaded resistance against the first plate assembly and the second plate assembly so as to prevent relative movement between the first plate assembly and the second plate assembly when the primary positioning system experiences shock and vibration weaker than the preloaded resistance.

20. The system of claim 19, wherein the primary positioning system includes at least one nitrogen gas die spring.

21. A method of attenuating shock and vibration between a first structure and a second structure, the method comprising the following steps:
bringing a first plate assembly and a second plate assembly together to form at least one cavity having an initial volume;
arranging a plurality of cavernous members of an elastic material in the at least one cavity;
uniting the first plate assembly and the first structure;
uniting the second plate assembly and the second structure; and
allowing shock and vibration to cause the first plate assembly and the second plate assembly to move relative to each other to reduce the initial volume of the at least one cavity so as to compress the plurality of cavernous members;
wherein compressing the plurality of cavernous members exerts pressure against the first plate assembly and the second plate assembly so as to absorb the shock and vibration.

22. The method of claim 21, further comprising
securing a first end of a primary positioning system against the first plate assembly; and
securing a second end of the primary positioning system against the second plate assembly;
wherein the primary positioning system provides a preloaded resistance against the first plate assembly and the second plate assembly so as to prevent relative movement between the first plate assembly and the second plate assembly when the primary positioning system experiences shock and vibration weaker than the preloaded resistance.

23. The method of claim 21, further comprising:
uniting the first plate assembly and an outer structure; and
suspending an inner structure from the second plate assembly within the outer structure.

24. The method of claim 23, further comprising:
securing a track system between the outer structure and the inner structure.

25. The method of claim 24,
wherein the track system includes at least one track, each at least one track having a corner post and a vertical sliding rail; and
wherein securing the track system between the outer structure and the inner structure includes the following steps:
fixedly attaching the corner post to the outer structure;
fixedly attaching the vertical slide rail to the inner structure; and
slidably engaging the vertical slide rail with the corner post;
wherein the inner structure may slide up and down the at least one track while connected to the vertical sliding rail.

26. The method of claim 25,
wherein the at least one track further includes a plurality of truck assemblies;
the method further comprising:
attaching the plurality of truck assemblies to the vertical sliding rail and
mounting the plurality of truck assemblies within the corner post, the plurality of trucks being an interface between the vertical sliding rail and the corner post.

27. The method of claim 26,
wherein each of the plurality of truck assemblies includes a truck and a truck adjuster,
the method further comprising:
attaching the truck adjuster to the truck, and
adjusting the truck adjuster to center the truck in the corner post.

28. A shock- and vibration-absorbing system comprising:
a first support device,
a second support device movably juxtaposed to the first support device, and
at least one elastic member;
wherein the first support device and the second support device together form at least one cavity having an initial volume in which the at least one elastic member is arranged, and wherein movement of the second support device relative to the first support device causes the at least one cavity to have a compressed volume less than the initial volume.

29. A shock- and vibration-absorbing system comprising:
a first containment means,
a second containment means movably juxtaposed to the first containment means and complementing the first containment means, and
a compressible medium;
wherein the first containment means and the second containment means together form at least one contained cavity having an initial volume in which the compressible medium exists, and wherein movement of the second containment means relative to the first containment means causes the at least one contained cavity to have a compressed volume less than the initial volume.

30. The system of claim 29, further comprising:
a shock- and vibration-absorbent shelving assembly comprising:
an outer structure connected to the first containment means,
an inner structure within the outer structure and connected to the second containment means, and
wherein the inner structure is suspended by the second containment means within the outer structure.

31. A method of attenuating shock and/or vibration between a first structure and a second structure, the method comprising:
forming at least one cavity having an initial volume by combining a first support device and a second support device so that the first support device and the second support device may move with respect to each other to reduce the initial volume of the at least one cavity;
arranging at least one elastic member in the at least one cavity;
attaching the first support device to the first structure; and
attaching the second support device to the second support structure.

32. A method of attenuating shock and/or vibration between a first structure and a second structure, the method having a response to an inward force of a given magnitude equivalent to the response to an outward force of the given magnitude, the method comprising:
forming at least one cavity having an initial volume by combining a first containment means and a second containment means so that the first containment means and the second containment means may move with respect to each other to reduce the initial volume of the at least one cavity;
arranging a compressible medium in the at least one cavity;
attaching the first containment means to the first structure; and
attaching the second containment means to the second support structure.

33. An automobile bumper assembly comprising:
a first plate assembly attached to an automobile frame,
a second plate assembly attached to a bumper, and
a plurality of cavernous members of an elastic material;
wherein the first plate assembly and the second plate assembly together form at least one cavity having an initial volume in which the plurality of cavernous members exist;
wherein shock and vibration passing between the bumper and the automobile frame cause the first plate assembly and the second plate assembly to move relative to each other to reduce the initial volume of the at least one cavity so as to compress the plurality of cavernous members; and
wherein compressing the plurality of cavernous members exerts pressure against the first plate assembly and the second plate assembly so as to absorb the shock and vibration.

34. A seismic isolation assembly comprising:
a first plate assembly attached to a building foundation,
a second plate assembly attached to a building frame,
a primary positioning system having a first end in contact with the first plate assembly and a second end in contact with the second plate assembly, and
a plurality of elastic members;
wherein the first plate assembly and the second plate assembly together form at least one cavity having an initial volume in which the plurality of elastic members exist;
wherein the first end and the second end the primary positioning system press against the first plate assembly and the second plate assembly to maintain the initial volume of the at least one cavity;
wherein the primary positioning system provides a preloaded resistance against the first plate assembly and the second plate assembly so as to prevent relative movement between the first plate assembly and the second plate assembly when the primary positioning system experiences forces weaker than the preloaded resistance;
wherein seismic shock and vibration passing between the building foundation and the building frame create forces on the primary positioning system greater than the preloaded resistance, overcoming resistance of the primary positioning system between the first plate assembly and the second plate assembly, allowing the first plate assembly and the second plate assembly to move relative to each other to reduce the initial volume of the at least one cavity so as to compress the plurality of elastic members; and
wherein compressing the plurality of elastic members exerts pressure against the first plate assembly and the second plate assembly so as to absorb the seismic shock and vibration.

35. A track system comprising at least one track, each at least one track having a corner post to be fixedly attached to a first structure and a sliding rail to be attached to a second structure, the sliding rail slidably engaging the corner post, whereby the second structure may slide linearly with respect to the first structure.

36. The system of claim 35, wherein the corner post includes an interior groove, the interior groove having angular sides and an opening to an exterior side of the corner post, the opening being narrower than the interior groove is wide.

37. The system of claim 36, wherein the at least one track includes at least one truck assembly attached to the sliding rail and mounted within the interior groove, the at least one truck assembly forming an adjustable interface between the sliding rail and the corner post.

38. The system of claim 37, wherein the at least one truck assembly includes a truck and a truck adjuster positioned against the truck, the truck adjuster serving to center the truck in the interior groove.

39. The system of claim 38, wherein:
the truck adjuster forms a wedge;
the truck has two wings having angular mating surfaces substantially complementary to the angular sides of the interior groove, the wings having between them a space suitably sized and shaped to receive the truck adjuster; and,
the truck assembly with the truck adjuster wedged between the two wings substantially complements the cross-sectional geometry of the interior groove.

40. The system of claim 39, wherein:
the angular sides are machined flat at a side angle relative to a centerline of the interior groove, and
the angular mating surfaces are slightly rounded and splayed from the centerline by a mating angle complementary to the side angle;
whereby each angular mating surface contacts a complementary angular side with a mating area of less than a total area of the angular mating surface.
